(19) United States
(12) Patent Application Publication
(10) Pub. No.: US 2013/0273908 A1
(43) Pub. Date: Oct. 17, 2013

(54) Specifying Available Telecommunication Standards in Respective Geographic Regions Based on Mobile Country Code

(71) Applicants: Karthik Anantharaman, Sunnyvale, CA (US); Sang Ho Baek, Palo Alto, CA (US); Bbarath Narasimha Rao, Sunnyvale, CA (US); Madhusudan Chaudhary, Cupertino, CA (US)

(72) Inventors: Karthik Anantharaman, Sunnyvale, CA (US); Sang Ho Baek, Palo Alto, CA (US); Bbarath Narasimha Rao, Sunnyvale, CA (US); Madhusudan Chaudhary, Cupertino, CA (US)

(21) Appl. No.: 13/604,529

(22) Filed: Sep. 5, 2012

Related U.S. Application Data
(60) Provisional application No. 61/624,217, filed on Apr. 13, 2012.

(51) Int. Cl. H04W 8/02; H04W 88/02

(52) U.S. Cl. 455/432.1

(57) ABSTRACT

A user equipment (UE) device may communicate according to at least two telecommunication standards. The UE may generate a second preferred roaming list based on a first preferred roaming list. The first preferred roaming list may indicate geographic locations which support a first telecommunication standard, of which some may also support a second telecommunication standard. The second preferred roaming list may indicate geographic locations which support only the first telecommunication standard and may also indicate geographic locations which support both the first telecommunication standard and the second telecommunication standard. The second preferred roaming list may be used to perform roaming, which may facilitate the UE avoiding searching for the second telecommunication standard in geographic locations which support only the first telecommunication standard.

### PRIORITY CLAIM

The present application claims benefit of priority to U.S. Provisional Application No. 61/624,217 titled “Specifying Available Telecommunication Standards in Respective Geographic Regions Based on Mobile Country Code” and filed on Apr. 13, 2012, whose inventors are Karthik Anantharaman, Sang Ho Baek, Bharath Narasimha Rao, and Madhusudan Chaudhary, and which is hereby incorporated by reference in its entirety as thought fully and completely set forth herein.

### FIELD OF THE INVENTION

The present application relates to wireless communication, and more particularly to a system and method for specifying telecommunication standards available in respective geographical regions based on mobile country codes.

### DESCRIPTION OF THE RELATED ART

Wireless communication systems are rapidly growing in usage. Further, wireless communication technology has evolved from voice-only communications to also include the transmission of data, such as Internet and multimedia content. Therefore, improvements are desired in wireless communication.

Wireless network operators can deploy new radio access technologies (RATs) in parallel with earlier generation radio access technologies, and wireless networks can support multiple radio access technologies simultaneously to provide smooth transitions through multiple generations of mobile wireless devices. For example, a representative wireless network can include simultaneous support for the Third Generation Partnership Project (3GPP) Long Term Evolution (LTE) wireless communication protocol and the Third Generation Partnership Project 2 (3GPP2) CDMA2000 1x (also referred to as 1xRTT or 1x) wireless communication protocol. This exemplary “simultaneous” wireless network can support circuit switched voice connections through a first wireless network that uses the CDMA2000 1x wireless communication protocol and packet switched connections (voice or data) through a second wireless network that uses the LTE wireless communication protocol.

The 3GPP wireless communications standards organization develops mobile communication standards that include releases for Global System for Mobile Communications (GSM), General Packet Radio Service (GPRS), Universal Mobile Telecommunications System (UMTS), Long Term Evolution (LTE) and LTE Advanced standards. The 3GPP2 wireless communications standards organization develops mobile communication standards that include CDMA2000 1xRTT and 1xEV-DO standards.

Dual mode (or multimode) UE devices may refer to UE devices that are compatible with a plurality of RATs. Dual mode mobile wireless devices may include separate signal processing chips that each can support a different RAT (or wireless communication protocol), such as one signal processing chip for the CDMA2000 1x wireless network and another signal processing chip for the LTE wireless network.

In some wireless communication systems, multimode system selection (MMSS) provides a user equipment (UE) device the ability to select the best possible radio access technology (RAT) (also referred to as “telecommunication standard”) in a given area. The 3GPP2 (Third Generation Partnership Project 2) MMSS (Multimode System Selection) Location Associated Priority List (MLPL) uses the Mobile Country Code (MCC) to group a set of radio access technologies available in a location. MLPL tables or records define groups of network identifiers (NIDs) (also referred to as location groups) that may be present in the same geographic region. When a network is detected that belongs to a Location Group in the MLPL, the UE device determines the appropriate radio access technology priorities to use based on the MLPL. The granularity of this location is in the Mobile Country Code (MCC) and/or Mobile Network Code (MNC) range for 3GPP systems and in the System Identifier (SID) and/or Network Identifier (NID) range for 3GPP2 systems.

In order to differentiate between locations where 3GPP and 3GPP2 coexist versus where they do not, SID and NID information are used to create two separate location groups in the MLPL. The creation of two separate location groups tends to be suboptimal, leading to a very large MMSS Location Associated Priority List (MLPL) since all SIDs have to be included in the MLPL.

Therefore, it would be desirable to provide a more efficient way to specify telecommunication standards available in respective geographical regions, and more particularly to specify or isolate areas where there is no coexistence between 3GPP and 3GPP2 systems.

### SUMMARY

Embodiments of the disclosure may relate to a method for a user equipment (UE) device to specify presence or absence of radio access technologies (RATs), also referred to as telecommunication standards, in a given geographical area. In at least some embodiments the method operates to disassociate telecommunication standards in a given geographical area based on mobile country codes.

According to some embodiments, the system may be a UE device. The UE device may include a memory, such as a smart card and/or subscriber identity module (SIM), for storing one or more of a first preferred roaming list (PRL), a location priority list (LPL), and/or a system priority list (SPL). The UE device may further include one or more antennas for performing wireless communication with base stations. The UE may be configured to communicate wirelessly using multiple (e.g., at least two) RATs or telecommunication standards. The UE device may also include a processor, which may be configured to implement part or all of the method, e.g., by executing program instructions stored on a memory medium (e.g., a non-transitory computer-readable memory medium).

The method may include storing the first PRL, e.g., in a memory such as a smart card. The first PRL may include information regarding geographic regions or locations which support a first telecommunication standard. Some of the geographic locations (“first geographic locations”) may support both the first telecommunication standard and also a second telecommunication standard. Other of the geographic locations (“second geographic locations”) may support only the first telecommunication standard. In some embodiments, the first PRL may associate (e.g., store) a first mobile country code (MCC) with the first geographic locations and a second mobile country code (MCC) with the second geographic locations. For example, the first PRL may associate the first MCC with the first telecommunication standard, or networks that operate according to the first telecommunication standard, for the first geographic locations, while the second MCC may be associated with the first telecommunication standard, or networks that operate according to the first telecommunication standard, for the second geographic locations.

The method may further include generating a second preferred roaming list based on the first preferred roaming list. The second preferred roaming list may include information regarding the same geographic locations as the first preferred roaming list, in some embodiments. The second preferred roaming list may indicate that the first geographic locations support the first telecommunication standard and the second telecommunication standard, and may also indicate that the second geographic locations support only the first telecommunication standard. For example, in some embodiments, records having entries for both the first telecommunication standard and the second telecommunication standard may be generated in the second preferred roaming list for the first geographic locations based at least in part on the first MCC in the first preferred roaming list. Similarly, records having entries for only the first telecommunication standard may be generated in the second preferred roaming list for the second geographic locations based at least in part on the second MCC in the first preferred roaming list. In some embodiments, the second MCC may be an invalid MCC.

In some embodiments, a location priority list may also be stored (e.g., also on the smart card). The location priority list may indicate that at least some geographic locations which support the first telecommunication standard and have the first MCC also support the second telecommunication standard. Thus, the records having entries for both the first telecommunication standard and the second telecommunication standard in the second preferred roaming list for the first geographic locations may be generated based at least in part on the location priority list. The location priority list may be an MMSS Location Priority List (MLPL) in some embodiments.

The method may further include selecting a telecommunication standard while roaming based on the second PRL. In some embodiments, for some or all of the second geographic locations which support only the first telecommunication standard, the UE device may not search for the second telecommunication standard. For example, the first telecommunication standard might be selected while in a second geographic location based on the second preferred roaming list, and the UE device may not search for the second telecommunication standard in the second geographic location based on the second preferred roaming list. Communication may be established with a base station that operates according to the selected telecommunication standard, in some embodiments.

Note that in some embodiments, the first telecommunication standard may be a 3GPP2 standard and the second telecommunication standard may be a 3GPP standard. Additionally, in some embodiments, the first preferred roaming list may be an IS-683D preferred roaming list, while the second preferred roaming list may be an IS-683E preferred roaming list.

Embodiments of the disclosure are also directed to memory medium (e.g., a non-transitory computer-readable memory medium) configured to implement part or all of the method, according to various embodiments.

Some embodiments of the disclosure may particularly relate to a system and method for efficiently isolating areas where there is no coexistence between 3GPP and 3GPP2 systems. For example, in one set of embodiments, 3GPP2 systems may be identified by one uniform mobile country code (MCC) and mobile network code (MNC) in addition to a system ID (SID) and a network ID (NID) in the IS-683D Preferred Roaming List (PRL). This MCC may be used in the MLPL to bind 3GPP2 and 3GPP systems. The MLPL may be used to create IS-683E PRLs that may be used to inform the device which RATs can be found in a given area. If a different (e.g., an invalid) MCC is used in the IS-683D PRL to identify 3GPP2 geographic regions that do not coexist with 3GPP, this may facilitate the creation of an IS-683E PRL that will correctly carry the locations that show coexistence between 3GPP and 3GPP2 systems, and avoid showing coexistence between 3GPP and 3GPP2 systems in locations where only one RAT is supported.

### BRIEF DESCRIPTION OF THE DRAWINGS

A better understanding of the present invention can be obtained when the following detailed description of the embodiments is considered in conjunction with the following drawings.

FIG. 1A illustrates an exemplary (and simplified) wireless communication system according to one embodiment;

FIG. 1B illustrates a base station in communication with user equipment according to one embodiment;

FIG. 2 illustrates an exemplary block diagram of a user equipment device, according to one embodiment;

FIG. 3 is a flowchart of a method for operating a user equipment device which is configured to communicate using multiple telecommunication standards according to one set of embodiments;

FIGS. 4A-4I provide examples of one set of embodiments.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE EMBODIMENTS

### Acronyms

The following acronyms are used in the present Provisional patent application.

3GPP: Third Generation Partnership Project

3GPP2: Third Generation Partnership Project 2

DL: Downlink

MMSS: Multimode System Selection

MCC: Mobile Country Code

MLPL: MMSS Location Associated Priority List (MLPL)

MNC: Mobile Network Code

NID: Network Identifier

PRL: Preferred Roaming List

RAT: Radio Access Technology

SID: System Identifier

SIM: Subscriber Identity Module

UL: Uplink

UMTS: Universal Mobile Telecommunications System

LTE: Long Term Evolution

### Terms

The following is a glossary of terms used in the present application:

Memory Medium—Any of various types of memory devices or storage devices. The term “memory medium” is intended to include an installation medium, e.g., a CD-ROM, floppy disks 104, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may comprise other types of memory as well or combinations thereof. In addition, the memory medium may be located in a first computer in which the programs are executed, or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, PDAs, portable Internet devices, music players, data storage devices, or other handheld devices, etc. In general, the term “UE” or “UE device” can be broadly defined to encompass any electronic, computing, and/or telecommunications device (or combination of devices) which is easily transported by a user and capable of wireless communication.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

### Communication System

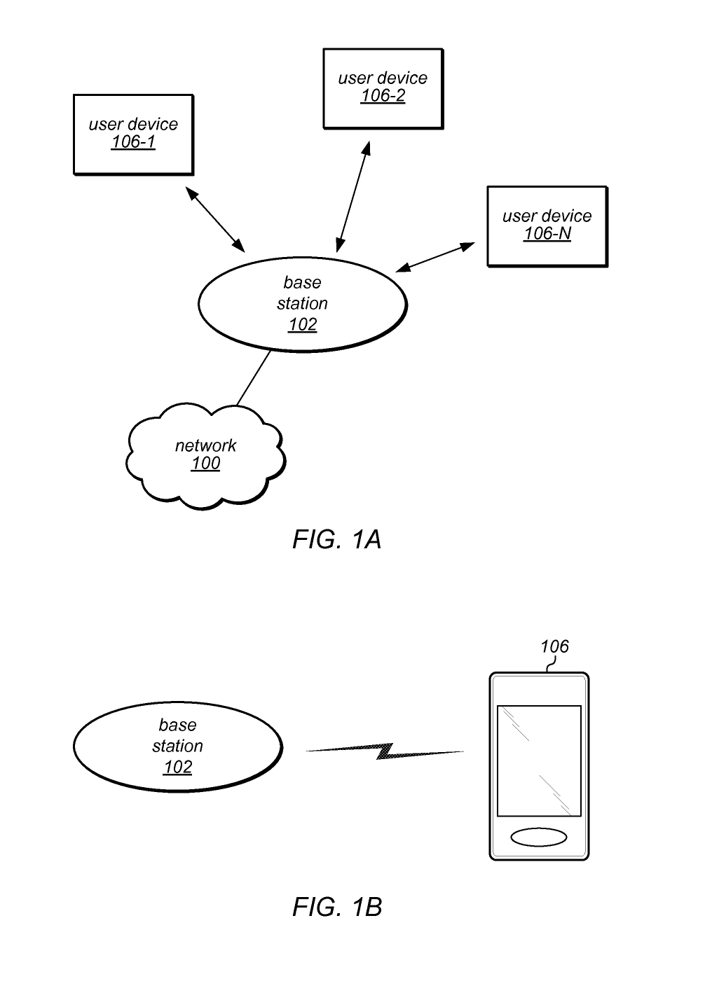

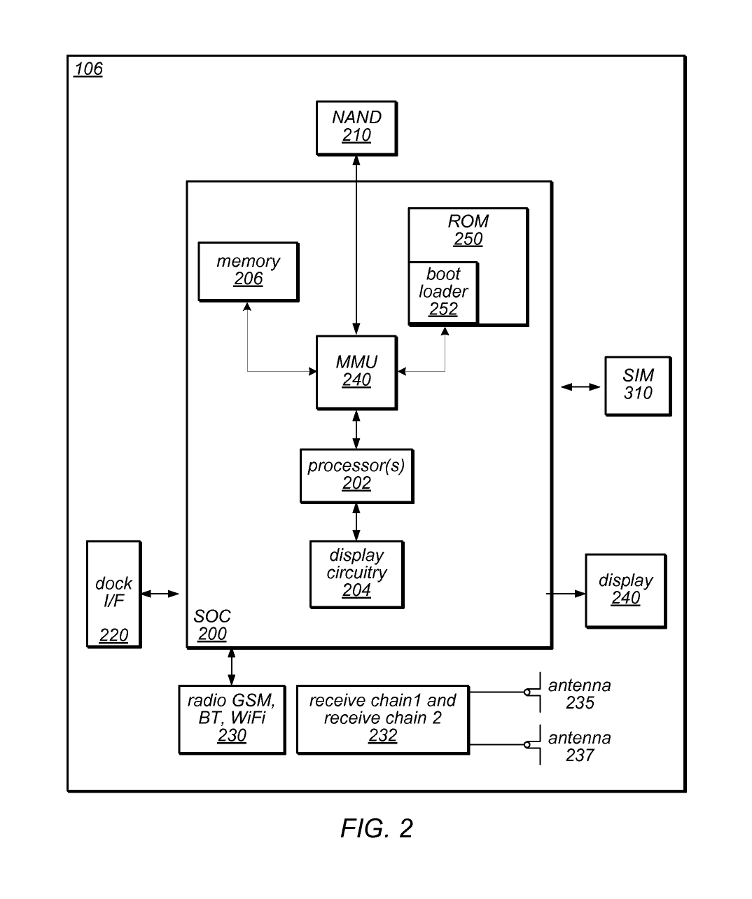

FIG. 1A illustrates an exemplary (and simplified) wireless communication system. It is noted that the system of FIG. 1A is merely one example of a possible system, and embodiments of the invention may be implemented in any of various systems, as desired.

As shown, the exemplary wireless communication system includes a base station 102 which communicates over a transmission medium with one or more user devices 106-1 through 106-N. Each of the user devices may be referred to herein as a “user equipment” (UE). Thus, the user devices are referred to as UEs or UE devices.

The base station 102 may be a base transceiver station (BTS) or cell site, and comprises hardware that enables wireless communication with the user devices 106-1 through 106-N. The base station 102 may also be equipped to communicate with a network 100. Thus, the base station 102 may facilitate communication between the user devices and/or between the user devices and the network 100.

The base station 102 and the user devices may be configured to communicate over the transmission medium using any of various radio access technologies (RATs), also referred to as wireless communication technologies or telecommunication standards, such as GSM, CDMA, WLL, WAN, WiFi, WiMAX etc.

At least one UE 106, and possibly each UE 106, may be capable of communicating using multiple telecommunication standards. For example, a UE 106 might be configured to communicate using either of a 3GPP telecommunication standard (such) as LTE or a 3GPP2 telecommunication standard (such as CDMA2000). Other combinations of telecommunication standards (including more than two telecommunication standards) are also possible.

A UE 106 may thus be able to communicate with base station 102 using a first telecommunication standard, e.g., while in the geographical area served by base station 102. The UE 106 may also be able to communicate with other base stations which utilize the first telecommunication standard, e.g., while in geographical locations served by the other base stations which utilize the first telecommunication standard. In addition, a UE 106 which is configured to communicate using multiple telecommunication standards may also be able to communicate with base stations which utilize a second telecommunication standard, e.g., while in geographical locations served by the base stations which utilize the second telecommunication standard. Note that in some cases, a base station may be able to communicate with a UE using any of multiple telecommunication standards. For example, base station 102 may be able to communicate with a UE 106 using either a first telecommunication standard or a second telecommunication standard (or both, simultaneously, e.g., using different antennas). In other cases, a particular base station may only be configured to communicate with UE devices using one telecommunication standard.

FIG. 1B illustrates user equipment 106 (e.g., one of the devices 106-1 through 106-N) in communication with the base station 102. The UE 106 may be a device with wireless network connectivity such as a mobile phone, a hand-held device, a computer or a tablet, or virtually any type of wireless device.

The UE may include a processor that is configured to execute program instructions stored in memory. The UE may perform any of the methods embodiments described herein by executing such stored instructions. In some embodiments, the UE may include a programmable hardware element such as an FPGA (field-programmable gate array) that is configured to perform any of the method embodiments described herein, or any portion of any of the method embodiments described herein.

In some embodiments, the UE 106 may be configured to communicate using any of multiple telecommunication protocols (e.g., wireless telecommunication protocols). For example, the UE 106 may be configured to communicate using either of CDMA 2000 or LTE. Other combinations of telecommunication standards are also possible.

In some embodiments, the UE 106 may include a plurality of receive antennas and a corresponding plurality of receive chains. The term “receive chain” may refer to a processing path for the received signal. For example, the UE 106 may include separate signal processing chips, each having a respective receive chain, for each of multiple wireless communication protocols. Alternatively (or in addition), multiple wireless communication protocols may share one or more parts of a receive chain in the UE 106 in some embodiments.

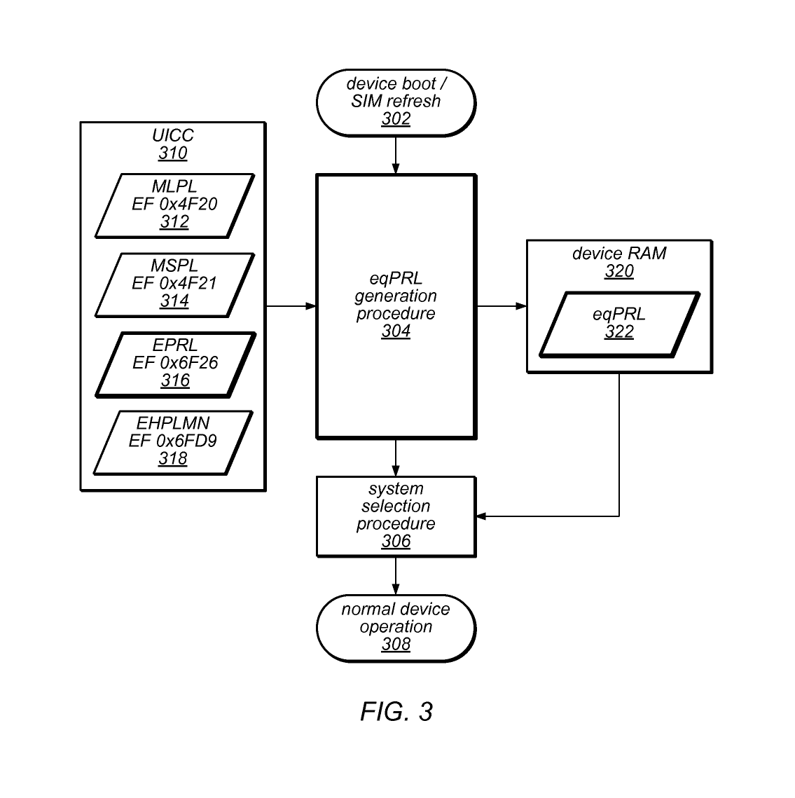

### FIG. 2—Exemplary Block Diagram of a UE

FIG. 2 illustrates an exemplary block diagram of a UE 106. As shown, the UE 106 may include a system on chip (SOC) 200, which may include portions for various purposes. For example, as shown, the SOC 200 may include processor(s) 202 which may execute program instructions for the UE 106 and display circuitry 204 which may perform graphics processing and provide display signals to the display 240. The processor(s) 202 may also be coupled to memory management unit (MMU) 240, which may be configured to receive addresses from the processor(s) 202 and translate those addresses to locations in memory (e.g., memory 206, read only memory (ROM) 250, NAND flash memory 210) and/or to other circuits or devices, such as the display circuitry 204, radio 230, connector I/F 220, and/or display 240. The MMU 240 may be configured to perform memory protection and page table translation or set up. In some embodiments, the MMU 240 may be included as a portion of the processor(s) 202.

In the embodiment shown, ROM 250 may include a bootloader 252, which may be executed by the processor(s) 202 during boot up or initialization. As also shown, the SOC 200 may be coupled to various other circuits of the UE 106. For example, the UE 106 may include various types of memory (e.g., including NAND flash 210), a connector interface 220 (e.g., for coupling to the computer system), the display 240, and wireless communication circuitry (e.g., for LTE, CDMA2000, Bluetooth, WiFi, etc.).

The UE device 106 may include at least one antenna, and in some embodiments multiple antennas, for performing wireless communication with base stations. For example, the UE device 106 may use antennas 235 and 237 to perform the wireless communication. The UE may be configured to communicate wirelessly using multiple (e.g., at least two) telecommunication standards. As described herein, the UE 106 may include hardware and software components for operating a UE device which is configured to communicate using multiple telecommunication protocols according to embodiments of this disclosure.

As shown, the UE 106 may include a memory medium, which may be comprised on a SIM (Subscriber Identity Module) 310, which may also be referred to as a smart card. The SIM 310 may take the form of a removable SIM card. As one example, the SIM 310 may be a Universal Integrated Circuit Card (UICC) 310. In some embodiments, the SIM 310 may store one or more of a first preferred roaming list (PRL), a location priority list (LPL), and/or a system priority list (SPL). In other embodiments, the UE 106 includes a non-volatile memory such as flash memory 210 where one or more of the above files (PRL, LPL, and/or SPL) are stored or provisioned. Thus, for example, the UE 106 may store these files in an embedded SIM (implemented in a memory on the UE device 106), or in a Universal Integrated Circuit Card (UICC), also referred to as 310. Therefore, the memory medium which stores the above files is intended to include current implementations and future advancements in smart card and SIM technologies, including Embedded SIM, eUICC, etc.

The first PRL may include information regarding geographic regions or locations which support a first telecommunication standard. Some of the geographic locations (“first geographic locations”) may support both the first telecommunication standard and also a second telecommunication standard. Other of the geographic locations (“second geographic locations”) may support only the first telecommunication standard. In some embodiments, the first PRL may associate (e.g., store) a first mobile country code (MCC) with the first geographic locations and a second mobile country code (MCC) with the second geographic locations. For example, the first PRL may associate the first MCC with the first telecommunication standard, or networks that operate according to the first telecommunication standard, for the first geographic locations, while the second MCC may be associated with the first telecommunication standard, or networks that operate according to the first telecommunication standard, for the second geographic locations.

The processor 202 of the UE device 106 may be configured to implement part or all of the methods described herein, e.g., by executing program instructions stored on a memory medium (e.g., a non-transitory computer-readable memory medium). In other embodiments, processor 202 may be configured as programmable hardware element, such as an FPGA (Field Programmable Gate Array), or as an ASIC (Application Specific Integrated Circuit).

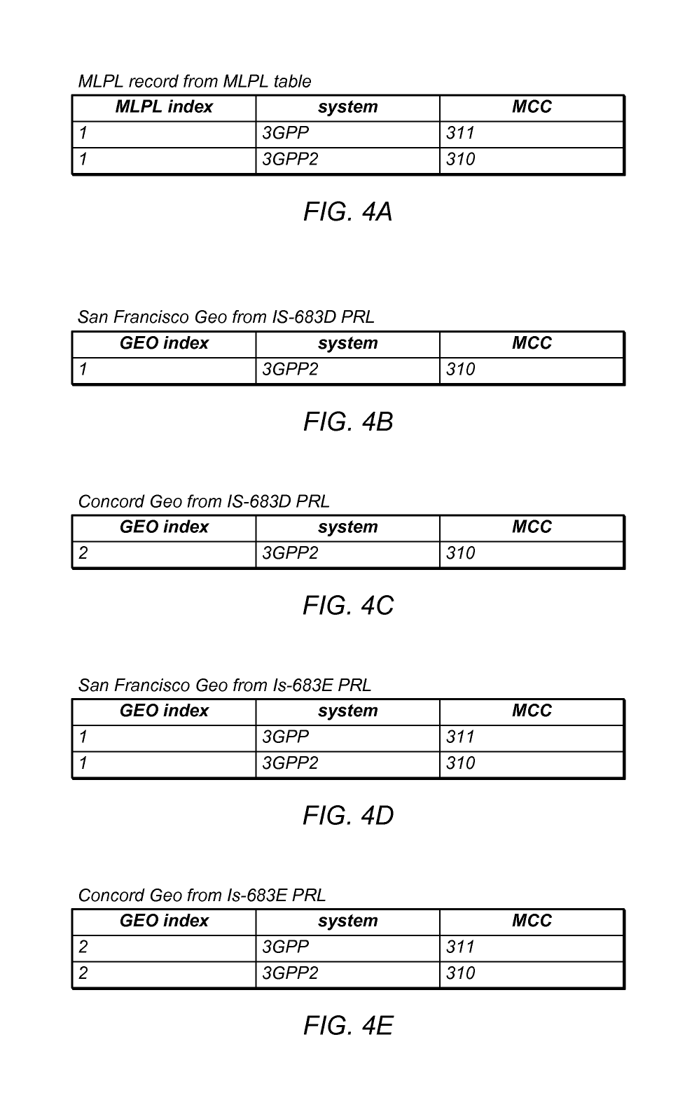

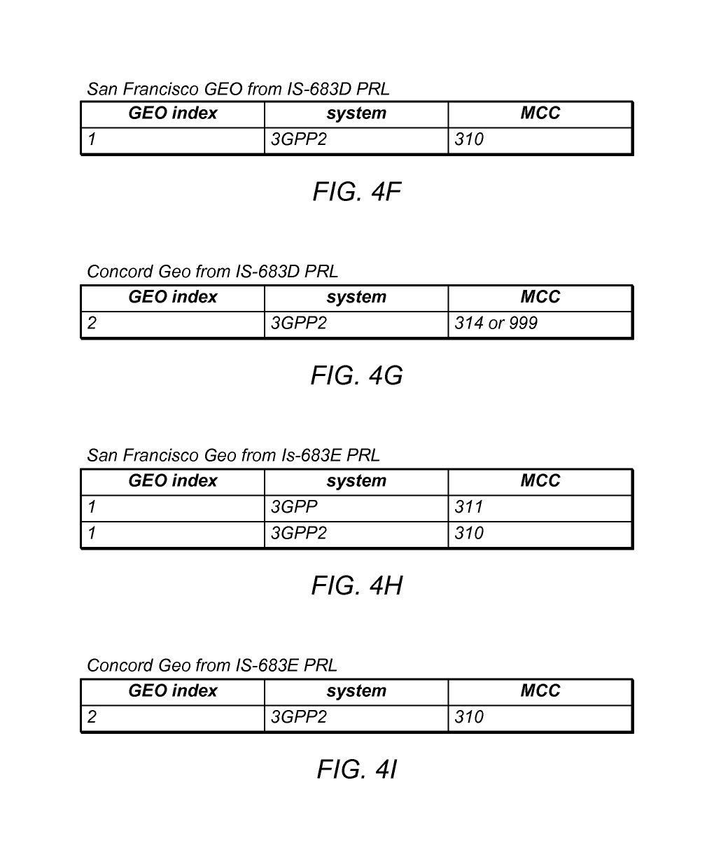

### FIGS. 3-4

The following section relates to a method for operating a user equipment (UE) device 106 which is configured to communicate using multiple telecommunication standards according to one set of embodiments. References are also provided to FIG. 4, which represents one example of such a process, which might be implemented in a UE 106 which is capable of communicating using a 3GPP telecommunication standard (such as LTE) and a 3GPP2 telecommunication standard (such as CDMA2000) according to one set of embodiments. The method shown in FIG. 3 may be used in conjunction with any of the systems or devices shown in the above Figures, among other devices. In various embodiments, some of the method elements shown may be performed concurrently, in a different order than shown, or may be omitted. Note also that additional method elements may also be performed as desired.

The UE device 106 may be a multi-mode wireless device; in other words, the UE 106 may be configured to communicate using multiple radio access technologies (RATs) or telecommunication standards. Depending on the location of the device, it may be preferable to join one type of network at one time, and another type of network at another time. For example, one geographic region might only support one type of network, while a different geographic region might only support the other type of network. Additionally, in some geographic areas, both types of networks may be supported, in which case one type of network may be preferred (e.g., because it is a home network, because it offers more and/or better communication capabilities, etc).

In order to account for the various possibilities available to such a multi-mode UE device 106, the UE device 106 may employ a Multi-Mode System Selection (MMSS) capability in order to select a preferred telecommunication standard to use in a given area.

The UE 106 may initially boot up (or alternatively, may perform a SIM refresh), e.g., as shown in the exemplary embodiment of FIG. 3 in step 302. One or more priority lists may be made available to the UE device in order to assist the UE to select a telecommunication standard. According to some embodiments, one or more such priority lists may be stored on a smart card, such as Universal Integrated Circuit Card (UICC) 310. In some embodiments, priority lists may be stored in a subscriber identity module (SIM) on the smart card, or in non-volatile memory on the UE 106. The priority lists may be made available to the UE 106 prior to initial operation of the UE (e.g., during configuration of the UE 106 by a service provider) in some embodiments. Alternatively, or in addition, the priority lists may be made available (and/or updated) during operation of the UE device 106, e.g., by request of a user, or automatically. Automatic updating or initial downloading of the priority lists to the smart card of the UE device 106 may be initiated by either a base station (e.g., the network/service provider) or the UE device 106 itself, according to various embodiments.

It may be common for one priority list (a “location priority list” or “LPL”) to be used to group sets of networks (which may operate according to different telecommunication standards) which may be present in the same geographic region. In the exemplary embodiment of FIG. 3, MMSS Location Priority List (MLPL) 312 may function as an LPL in some embodiments.

The LPL may also assign a relative priority to each network and/or telecommunication standard per listing, in some embodiments. Alternatively, the LPL may refer to (or include pointers to) one or more additional lists which assign relative priority to each of multiple networks (and/or telecommunication standards) according to different scenarios (e.g., home, roaming, scenarios specific to particular geographic areas, or other scenarios). Such a set of lists may be referred to as a “system priority list” or “SPL”. In the exemplary embodiment of FIG. 3, MMSS System Priority List (MSPL) 314 may function as an SPL in some embodiments.

A further priority list that may be available in some embodiments is a first preferred roaming list (PRL). The first PRL may include information relating to the availability of networks which operate according to a first telecommunication standard in various geographic locations. One example of such a first PRL is the IS-683D PRL which may be used in UE devices configured to communicate using a 3GPP2 telecommunication protocol in some embodiments. In the exemplary embodiment of FIG. 3, EPRL 316 (which may also be an IS-683D PRL) may function as a first PRL.

In at least some embodiments of the invention, the first PRL includes information that is useable to identify geographic regions which support multiple telecommunication standards and regions which support only one telecommunication standard (or a smaller subset). It is noted that in current systems telecommunication carriers may not provide this type of information in the first PRL. However, in embodiments of the invention, the carriers provide this information in the first PRL. As one example, the carriers may provide this information as MCCs, as described further below.

The first PRL may enable the UE device 106 to identify and select access points (e.g., cells provided by base stations) provided by its service provider outside of its “home” region, e.g., while “roaming”. In some embodiments the first PRL may also assist the UE 106 in identifying access points provided by other service providers, which may utilize the same telecommunication standard as the home service provider of the UE device, e.g., while roaming in a different geographic region than its home region. Note that the first PRL may also assist in identifying networks/access points within the UE device's home region (which may typically be provided by its service provider, but may also or alternatively be provided by other service providers), in some embodiments. Alternatively, another file or data structure, such as equivalent home public land mobile network identifier (EHPLMN) 318 shown in FIG. 3, may be available to assist in identifying/selecting home region networks/access points. The first PRL may also provide information used for identifying the availability of telecommunication standards as described herein.

Together, the first PRL and the LPL (and in some cases the SPL) may be used by the UE device 106 to construct a second PRL which includes information relating to the availability of multiple telecommunication standards in various geographic locations. That is, since the first PRL may include information identifying which networks operating according to a first telecommunication standard may be available in each of multiple geographical regions, and the LPL may include information identifying which networks of different telecommunication standards may co-exist in a geographic region, the UE 106 may be able to combine the information to generate a second PRL which includes information relating to the availability of networks which operate according to any of multiple telecommunication standards in various geographic locations. The SPL (or LPL) may also be used to prioritize the networks listed in the second PRL for a given geographic region, in some embodiments. The second PRL may then be stored.

According to the exemplary embodiment of FIG. 3, the process of generating the second PRL based on the first PRL and the LPL (and possible the SPL) is shown as step 304 and is performed by the UE device 106. The second PRL may be exemplified by eqPRL 322 (which may be an IS-683E PRL, in some embodiments) shown in FIG. 3, which may be stored in device RAM 320.

Once the second PRL has been generated (and stored), it may be used by the UE to search for and select a network in any given geographical region. This is shown in the exemplary embodiment of FIG. 3 as step 306.

Once a network has been selected, normal device operation may commence. This is shown in the exemplary embodiment of FIG. 3 as step 308.

In some embodiments of the invention, the base station 102 (e.g., a telecommunication carrier) may perform the operation of creating the second PRL (e.g., eqPRL 322) as described herein. In these embodiments, the base station 102 creates and provides the second PRL in a wireless manner to the UE device 106, which receives and stores the second PRL, either in the SIM 310 or RAM 320.

### FIGS. 4A-4I

There are a number of possible ways in which the first PRL and LPL could be correlated, and in which a second PRL could be generated therefrom. FIGS. 4A-4I illustrate two exemplary such ways.

One possible way of correlating the first PRL and the LPL may include the use of mobile country codes (MCCs). For example, the MLPL associates networks that operate according to different telecommunication standards based on MCCs. Similarly, the IS-683D PRL includes MCCs for networks listed for each geographic region. Thus, a naïve way of generating the second PRL (e.g., an IS-683E PRL) might include adding entries to the second PRL for each network (or telecommunication standard) listed in the LPL entry which corresponds to a network and MCC listed in the first PRL for a given geographic region.

One problem with this method is that using MCCs to associate networks of different telecommunication standards may be such a coarse level of granularity as to introduce inaccuracy to the second PRL, which may result in inefficient operation of UEs 106. FIGS. 4A-4E illustrate one such problematic scenario, which corresponds to where the LPL is embodied as an MLPL, the first PRL is embodied as an IS-683D PRL, and the second PRL is embodied as an IS-683E PRL. In this exemplary scenario, consider two geographic regions which do not share the same network availability. The first geographic region (e.g., San Francisco, Calif.) might support a network that operates according to a 3GPP2 standard and a network that operates according to a 3GPP standard. The second geographic region (e.g., Concord, Calif.) might support only the 3GPP2 network. Note that the MCC for the 3GPP2 network may be the same in both San Francisco and Concord.

Because some geographic regions having a particular MCC (e.g., at least the first geographic region) support both telecommunication standards (i.e., the telecommunication standards may co-exist in some geographic regions), the LPL may associate the 3GPP network with the 3GPP2 network for that MCC. This is shown in FIG. 4A, in which an entry exists for the 3GPP network having MCC 311 and for the 3GPP2 network having MCC 310.

Since both geographic regions support the 3GPP2 network, this network (and corresponding MCC) may be listed for each of the two geographic regions in the first PRL, as shown in FIGS. 4B and 4C.

In order to generate a record in the second PRL for the first geographic region, then, the record for the first geographic region from the first PRL may first be examined. As shown in FIG. 4B, the listing may include the 3GPP2 network having MCC 310. This may be correlated to the record in the LPL for the 3GPP2 network having MCC 310, which is the record shown in FIG. 4A in this particular scenario. Entries for the 3GPP network having MCC 311 and the 3GPP2 network having MCC 310 may thus be created for the first geographic region in the second PRL. This is shown in FIG. 4D. In this case, the record in the second PRL for the first geographic region accurately lists those networks which are supported in the first geographic region.

In order to generate a record in the second PRL for the second geographic region, the record for the second geographic region from the first PRL may also be examined. As shown in FIG. 4C, the listing may include the 3GPP2 network having MCC 310. This may also be correlated to the record in the LPL for the 3GPP2 network having MCC 310, which is again the record shown in FIG. 4A in this particular scenario. Entries for the 3GPP network having MCC 311 and the 3GPP2 network having MCC 310 may thus be created for the second geographic region in the second PRL. This is shown in FIG. 4E. In this case, the record in the second PRL for the second geographic region incorrectly lists both the 3GPP2 network (which is supported) and the 3GPP network (which is not supported) as being supported in the second geographic region.

Thus, in this case, because the second geographic region also supports the network that operates according to the first telecommunication standard and shares the same MCC, the second PRL would include a listing for the network that operates according to the second telecommunication standard, even though that network is not supported in the second geographic region. In this case, a UE that enters the second geographic region and consults its second PRL to determine for which networks to search may be forced to search for the network that operates according to the second telecommunication standard even though it is not supported.

Thus, embodiments of the invention may provide an alternative approach which is able to differentiate between regions with and without support for co-existence of networks of different telecommunication standards at a finer level of granularity (and thus higher accuracy). For example, at least some embodiments of the invention may include providing UEs 106 with a first PRL which lists different MCCs for networks which are known to co-exist with networks that operate according to other telecommunication standards and networks which do not co-exist with networks that operate according to other telecommunication standards. The UE 106 may then be configured to utilize such a first PRL to construct a second PRL in which networks in a given geographical area which do not coexist with networks of other telecommunication standards may be disassociated from networks of other telecommunication standards based on MCCs. As noted above, in other embodiments the telecommunication carrier (e.g., the base station 102) may perform the work of constructing the second PRL and providing the second PRL to the UEs 106.

FIGS. 4F-4I illustrate one such set of embodiments, according to one possible exemplary implementation. Consider the same scenario as regards the two geographic regions respective network availability. In the exemplary set of embodiments, in the first PRL (again embodied as an IS-683D PRL), the original country code may be used for geographic regions in which 3GPP2 networks coexist with 3GPP networks, such as the first geographic region. This is shown in FIG. 4F. For these geographic regions, consulting the LPL based on the MCC shown in the first PRL to determine whether any 3GPP (or other) networks coexist in the geographic region may result in correctly populating the second PRL with both the 3GPP network having MCC 311 and the 3GPP2 network having MCC 310, such as shown in FIG. 4H with respect to the first geographic region.

However, in the exemplary set of embodiments, for geographic regions in which 3GPP2 networks do not coexist with 3GPP networks, such as the second geographic region, an alternate MCC may be used in the first PRL. For example, an alternate valid MCC (such as 314) or a dummy/invalid MCC (such as 999) may be used to indicate that a network does not coexist with networks that operate according to different telecommunication standards in a particular geographic region. Thus, as shown in FIG. 4G, the 3GPP2 network may be listed for the second geographic region as having MCC 314 or 999 (note that other MCCs could alternatively be used) in the first PRL. For these geographic regions, the UE may be configured (e.g., programmed, or alternatively hardware-configured) to recognize that such an MCC indicates that the network does not coexist with networks that operate according to different telecommunication standards in these geographic regions. In the particular case of the second geographic region, this is shown in FIG. 4I: the record for the second geographic region in the second PRL is correctly populated with only the 3GPP2 network having MCC 310.

Thus, in this case, a UE that enters the second geographic region and consults its second PRL to determine for which networks to search may not search for the 3GPP network. Avoiding unnecessary searches for unsupported networks may potentially improve the efficiency of UEs implementing such a method, including improving battery life and performance of the UE.

Embodiments of the present invention may be realized in any of various forms. For example, in some embodiments, the present invention may be realized as a computer-implemented method, a computer-readable memory medium, or a computer system. In other embodiments, the present invention may be realized using one or more custom-designed hardware devices such as ASICs. In other embodiments, the present invention may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a computer system may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The computer system may be realized in any of various forms. For example, the computer system may be a personal computer (in any of its various realizations), a workstation, a computer on a card, an application-specific computer in a box, a server computer, a client computer, a hand-held device, a tablet computer, a wearable computer, etc.

Although the embodiments above have been described in considerable detail, numerous variations and modifications will become apparent to those skilled in the art once the above disclosure is fully appreciated. It is intended that the following claims be interpreted to embrace all such variations and modifications.

1. A user equipment (UE) device, the UE device comprising:
a memory medium which stores a first preferred roaming list, wherein the first preferred roaming list comprises information regarding geographic locations which support a first telecommunication standard, wherein the first preferred roaming list comprises a mobile country code (MCC) for the first telecommunication standard for each of the geographic regions, wherein a first MCC is stored in the first preferred roaming list for the first telecommunication standard for first geographic locations which support the first telecommunication standard and a second telecommunication standard, wherein a second MCC is stored in the first preferred roaming list for the first telecommunication standard for second geographic locations which support only the first telecommunication standard, wherein the second MCC is not natively associated with the first telecommunication standard;
an antenna for performing wireless communications with a base station;
a processor configured to generate a second preferred roaming list based on the first preferred roaming list, wherein the second preferred roaming list comprises information regarding the geographic locations which support the first telecommunication standard, wherein the second preferred roaming list indicates that the first geographic locations support the first telecommunication standard and the second telecommunication standard, wherein the second preferred roaming list indicates that the second geographic locations support only the first telecommunication standard;
wherein the UE device is configured to select a telecommunication standard while roaming based on the second preferred roaming list, wherein for the second geographic locations which support only the first telecommunication standard, the UE device does not search for the second telecommunication standard.

2. The UE device of claim 1,
wherein the processor is configured to generate records having entries for both the first telecommunication standard and the second telecommunication standard in the second preferred roaming list for the first geographic locations based at least in part on the first MCC in the first preferred roaming list;
wherein the processor is configured to generate records having entries for only the first telecommunication standard in the second preferred roaming list for the second geographic locations based at least in part on the second MCC in the first preferred roaming list.

3. The UE device of claim 1,
wherein the memory medium further stores a location priority list, wherein the location priority list indicates that at least some geographic locations which support the first telecommunication standard having the first MCC also support the second telecommunication standard;
wherein the processor is further configured to generate records having entries for both the first telecommunication standard and the second telecommunication standard in the second preferred roaming list for the first geographic locations based at least in part on the location priority list.

4. The UE device of claim 1,
wherein the second MCC is an invalid MCC.

5. The UE device of claim 1,
wherein the first preferred roaming list is an IS-683D preferred roaming list;
wherein the second preferred roaming list is an IS-683E preferred roaming list.

6. The UE device of claim 1,
wherein the first telecommunication standard comprises a 3GPP2 standard and the second telecommunication standard comprises a 3GPP standard.

7. The UE device of claim 1,
wherein the UE device further comprises a smart card, wherein the memory medium is implemented on the smart card.

8. The UE device of claim 1,
wherein the UE device further comprises a Subscriber Identity Module (SIM) card, wherein the memory medium is implemented on the SIM card.

9. The UE device of claim 1,
wherein the memory medium is a non-volatile memory of the UE device.

10. A method for operating a user equipment (UE) device that is configured for communication with a base station, wherein the UE device is configured to communicate according to at least two telecommunication standards, the method comprising:
storing a first preferred roaming list, wherein the first preferred roaming list comprises information regarding geographic locations which support a first telecommunication standard, wherein the first preferred roaming list comprises a mobile country code (MCC) for the first telecommunication standard for each of the geographic regions, wherein a first MCC is stored in the first preferred roaming list for the first telecommunication standard for first geographic locations which support the first telecommunication standard and a second telecommunication standard, wherein a second MCC is stored in the first preferred roaming list for the first telecommunication standard for second geographic locations which support only the first telecommunication standard, wherein the second MCC is not natively associated with the first telecommunication standard;
generating a second preferred roaming list based on the first preferred roaming list, wherein the second preferred roaming list comprises information regarding the geographic locations which support the first telecommunication standard, wherein the second preferred roaming list indicates that the first geographic locations support the first telecommunication standard and the second telecommunication standard, wherein the second preferred roaming list indicates that the second geographic locations support only the first telecommunication standard;
selecting the first telecommunication standard while in a second geographic location based on the second preferred roaming list;
establishing communication with a base station that operates according to the first telecommunication standard while in the second geographic location, wherein the UE device does not search for the second telecommunication standard in the second geographic location based on the second preferred roaming list.

11. The method of claim 10, wherein generating the second preferred roaming list comprises:
generating records having entries for both the first telecommunication standard and the second telecommunication standard in the second preferred roaming list for the first geographic locations based at least in part on the first MCC in the first preferred roaming list;
generating records having entries for only the first telecommunication standard in the second preferred roaming list for the second geographic locations based at least in part on the second MCC in the first preferred roaming list.

12. The method of claim 10, further comprising:
storing a location priority list, wherein the location priority list indicates that at least some geographic locations which support the first telecommunication standard having the first MCC also support the second telecommunication standard;
generating records having entries for both the first telecommunication standard and the second telecommunication standard in the second preferred roaming list for the first geographic locations based at least in part on the location priority list.

13. The method of claim 12, wherein the location priority is an MMSS Location Priority List (MLPL).

14. The method of claim 10, wherein the second MCC is an invalid MCC.

15. The method of claim 10,
wherein said storing comprises storing the first preferred roaming list on a Subscriber Identification Module (SIM) of the UE device.

16. The method of claim 10,
wherein said storing comprises storing the first preferred roaming list on a non-volatile memory of the UE device.

17. The method of claim 10,
wherein the first preferred roaming list is an IS-683D preferred roaming list;
wherein the second preferred roaming list is an IS-683E preferred roaming list.

18. The method of claim 10,
wherein the first telecommunication standard comprises a 3GPP2 standard and the second telecommunication standard comprises a 3GPP standard.

19. A non-transitory computer-readable memory medium comprising program instructions executable by a processor to:
read from a first preferred roaming list, wherein the first preferred roaming list comprises information regarding geographic locations which support a first telecommunication standard, wherein the first preferred roaming list comprises a mobile country code (MCC) for the first telecommunication standard for each of the geographic regions, wherein a first MCC is stored in the first preferred roaming list for the first telecommunication standard for first geographic locations which support the first telecommunication standard and a second telecommunication standard, wherein a second MCC is stored in the first preferred roaming list for the first telecommunication standard for second geographic locations which support only the first telecommunication standard, wherein the second MCC is not natively associated with the first telecommunication standard;
generate a second preferred roaming list based on the first preferred roaming list, wherein the second preferred roaming list comprises information regarding the geographic locations which support the first telecommunication standard, wherein the second preferred roaming list indicates that the first geographic locations support the first telecommunication standard and the second telecommunication standard, wherein the second preferred roaming list indicates that the second geographic locations support only the first telecommunication standard;
select a telecommunication standard with which to establish communication with a base station while roaming based on the second preferred roaming list.

20. A user equipment (UE) device, the UE device comprising:
a memory medium which stores a first preferred roaming list, wherein the first preferred roaming list comprises information regarding first geographic locations which support at least two telecommunication standards and second geographic locations which support only one of the telecommunication standards;
an antenna for performing wireless communications with a base station;
a processor coupled to the memory medium and configured to generate a second preferred roaming list based on the first preferred roaming list, wherein the second preferred roaming list indicates the first geographic locations which support the at least two telecommunication standards and the second geographic locations which support only one of the telecommunication standards;
wherein the UE device is configured to perform roaming based on the second preferred roaming list, wherein for at least some respective geographic regions the UE device does not search for a respective telecommunication standard that is not supported in the respective geographic regions.

21. The UE device of claim 20,
wherein the first preferred roaming list comprises a mobile country code (MCC) for each of the geographic regions, wherein a first MCC is stored for the first geographic locations which support the at least two telecommunication standards, and wherein a second MCC is stored for the second geographic locations which support only one of the telecommunication standards.

22. The UE device of claim 21, wherein the second MCC is an invalid MCC.

23. The UE device of claim 20, wherein the memory medium is comprised on a Subscriber Identification Module (SIM) of the UE device.

24. The UE device of claim 20,
wherein the first preferred roaming list is an IS-683D preferred roaming list;
wherein the second preferred roaming list is an IS-683E preferred roaming list.

25. A method for operating a user equipment (UE) device that is configured for communication with a base station, wherein the UE device is configured to communicate according to at least two telecommunication standards, the method comprising:
storing information in a first preferred roaming list regarding first geographic locations which support the at least two telecommunication standards and second geographic locations which support only one of the telecommunication standards;
generating a second preferred roaming list based on the first preferred roaming list, wherein the second preferred roaming list indicates the first geographic locations which support the at least two telecommunication standards and the second geographic locations which support only one of the telecommunication standards;
the UE device performing roaming based on the second preferred roaming list, wherein for at least some respective geographic regions the UE device does not search for a respective telecommunication standard that is not supported in the respective geographic regions.

26. The method of claim 25,
wherein the first preferred roaming list comprises a mobile country code (MCC) for each of the geographic regions, wherein a first MCC is stored for the first geographic locations which support the at least two telecommunication standards, and wherein a second MCC is stored for the second geographic locations which support only one of the telecommunication standards.

27. The method of claim 26, wherein the second MCC is an invalid MCC.

28. The method of claim 25,
wherein the UE device comprises a Subscriber Identification Module (SIM) which stores the first preferred roaming list.

29. The method of claim 25,
wherein the first preferred roaming list is an IS-683D preferred roaming list;
wherein the second preferred roaming list is an IS-683E preferred roaming list.

30. A user equipment (UE) device, the UE device comprising:
a smart card which stores a first preferred roaming list, wherein the first preferred roaming list comprises information regarding first geographic locations which support a first telecommunication standard;
an antenna for performing wireless communications with a base station;
a processor configured to generate a second preferred roaming list based on the first preferred roaming list, wherein the second preferred roaming list indicates the first geographic locations which support the first telecommunication standard, wherein the second preferred roaming list indicates that a subset of the first geographic locations also support a second telecommunication standard, wherein for at least some respective geographic regions that do not support the second telecommunication standard, the second preferred roaming list does not indicate that the second telecommunication standard is supported;
wherein the UE device is configured to perform roaming based on the second preferred roaming list, wherein for the at least some respective geographic regions that do not support the second telecommunication standard, the UE device does not search for the second telecommunication standard.

31. A user equipment (UE) device, the UE device comprising:
an antenna for performing wireless communications with a base station;
a processor configured to generate a preferred roaming list, wherein the preferred roaming list indicates first geographic locations which support at least two telecommunication standards and second geographic locations which support only one of the telecommunication standards;
wherein the UE device is configured to perform roaming based on the preferred roaming list, wherein for at least some respective geographic regions the UE device does not search for a respective telecommunication standard that is not supported in the respective geographic regions.
